(19) United States
(12) Patent Application Publication
(10) Pub. No.: US 2016/0367847 A1
(43) Pub. Date: Dec. 22, 2016

(54) Training Apparatus

(71) Applicant: David ANTUNES, Elizabeth, NJ (US)

(72) Inventor: David ANTUNES, Elizabeth, NJ (US)

(21) Appl. No.: 15/186,840

(22) Filed: Jun. 20, 2016

Related U.S. Application Data
(60) Provisional application No. 62/181,500, filed on Jun. 18, 2015.

(51) Int. Cl. A63B 5/16; A63B 71/06; A63K 3/04; G09B 19/00

(52) U.S. Cl. CPC A63B 5/16; G09B 19/0038; A63B 71/0622; A63K 3/043; A63B 2244/088

(57) ABSTRACT

An athletic training device and system may have a training apparatus having a first support having a first coupling mechanism where the first support is preferably vertically adjustable, a second support having a second coupling mechanism, where the second support is preferably vertically adjustable, at least two light sources coupled to the first support, at least one light receiver couple to the second support, where a first wireless transceiver is operably coupled to the at least one light receiver, and a sensing unit having a second wireless transceiver capable of communicating with the first wireless transceiver. The training device generally enables the creation of a virtual barrier that can be used in lieu of an actual barrier for athletic training purposes thereby decreasing the incidence of injury and increasing athlete confidence. When the device is needed for competition use, the required barrier can be coupled thereto.

### CLAIM OF PRIORITY

This application claims the priority of U.S. Application Ser. No. 62/181,500 filed on Jun. 18, 2015, the contents of which are fully incorporated herein by reference in its entirety.

### FIELD OF THE EMBODIMENTS

The field of the invention and its embodiments relate to athletic training and competition devices that can be used to improve the performance of an athlete competing in an athletic contest, namely track and field. In particular, there is a hurdle training device which may use an optically created “virtual hurdle board” and/or other techniques to remove the fear of injury and falling. The same device can also be used in competition by fitting it with the proper structural elements. Further, the same general concepts may be made to other training devices and/or athletic contests having barriers.

### BACKGROUND OF THE EMBODIMENTS

Sporting and athletic contests have likely existed since mankind came into being as a manner to improve our mastery over skills required for survival and to assert ranking positions in society. As our civilizations have evolved, these contests have changed dramatically often reflecting certain values and tenets that have arose and fallen over time.

Today many athletes begin practicing and training to improve their athletic prowess from a young age. However, part of learning a new skill entails overcoming fears, conditioning one's body to perform the skill, and becoming comfortable in not only performing but competing at that newfound skill. Many typical athletic skills are based in running, jumping, and the throwing of various implements (both specifically weighted and non-weighted). Many athletic contests require the combination of these skills working in harmony to achieve a desirable results. Hurdling is often regarded as one of the more technically challenging track and field events and can be one of the more challenging aspects of all sports, as it requires great athletic ability, timing, reflexes, and balance.

Hurdling is the act of maneuvering oneself over a number of barriers at a running or race pace. Failure to pass over a hurdle or interfering with another runner will likely result in disqualification, whereas simply hitting or knocking of a hurdle will typically slow down a runner, but not result in disqualification. The hurdle heights vary for both genders (men and women) as well as age level of the respective genders. Typically hurdles vary between 27″-42″ in height and are constructed of a base, two uprights, and a hurdle board spanning the two uprights. For example, many hurdles are positioned are 36″-39″ for high school aged men and 30″-33″ for high school aged women. However, collegiate and professional men have hurdles that are usually up to 42″ in height, whereas the women's height remain unchanged from the typical high school heights. In some instances, the hurdles may also be weighted.

In addition to the height requirements, the hurdles are positioned at specific points on the running surface depending on the length of the race. For example, in the 110 m hurdle race for men, the first hurdle is forty-five feet from the starting line. The distance between each hurdle is thirty feet thereafter. Thus, when one accounts for the overall height of the hurdle along with these specific locations on the track, it becomes apparent the amount of training required to master this athletic endeavor and how unnerving such a race can be for a novice and even seasoned athletes.

There have been a number of training aids developed to assist new athletes in learning these skills while continuing to permit them to feel “at ease” with this new experience. However, such training aids have a number of limitations and do not fully solve the issues sought to cure. For example, one of the biggest fears many athletes have is the fear of falling and injuring themselves during practice or the course of a race. Such a fall can cause serious injury including lacerations, abrasions, concussions, and fractures. Further, hitting a hurdle with the leg or ankle or other bodily part can be quite painful and result in bruising, cuts, bleeding, and potentially more severe injuries.

Attempts to prevent such injuries have manifested in foam hurdles or foam pieces to overlay a portion or the hurdle, namely the hurdle board. However, while such an invention may lessen an impact, the athlete may still readily trip over the device and fall and subsequently injuring themselves. In other variations, there are hurdles with fabric “boards” that are held on by hook and loop fasteners. These are dedicated training devices that could not be used for competition, and are typically geared towards younger athletes. Still yet, some training devices are geared towards more advanced athletes and would not take certain “novice” considerations into account and are not practical for such an implementation.

Thus, there is a need for a training device, namely for hurdle training, that provides for both a training apparatus and a competition ready hurdle. Further, such an apparatus should completely prevent one from impacting the apparatus thereby alleviating any concern with falling and/or injury and/or the intimidating height of the hurdle. The present invention and its embodiments meet and exceed these objectives.

### Review of Related Technology:

U.S. Pat. No. 5,005,828 pertains to a high jump ribbon assembly which contains a fabric ribbon and at least two brackets, each of which is adapted to be attached to a standard. The fabric ribbon contains a base material and at least two portions of fibrous fastener fabric attached to it. The brackets each have attached to them two separate pieces of complementary fibrous fastener fabric.

European Patent Application 209868 pertains to a device for measuring the vertical jumping ability of an athlete. The device having a plurality of optical emitters to emit a plurality of optical signals, a plurality of optical receivers to receive the optical signals, the optical receivers being arranged at a distance from the optical emitters such that the athlete during a vertical jumping movement interposes oneself between the optical emitters and the optical receivers to intercept at last one of the optical signals. A processing unit is used to process the height reaches by the athlete to obtain the requisite vertical jumping ability.

Japanese Patent Application 2006141770 pertains to an apparatus for measuring the height which an athlete actually clears in the high jump and the pole vault. A light emitting device having a plurality of light emitting elements linearly arranged is vertically attached to one of the two poles, a light receiving device having a plurality of light receiving elements linearly arranged is attached to the other pole, the light emitting device and the light receiving device are disposed to face each other, and the passing position of the athlete is detected by interception of light from the light emitting device by the athlete inhibiting arrival of the light at the light receiving device when the athlete passes between the two poles. That is, between the light emitting device and the light receiving device. Thereby, the height above a bar the athlete passes or the actual jumping height of the athlete can be detected. Further, the change of the height with time from the start of passage to the completion of the passage can be detected.

Korean Patent Application 1020110132193 pertains to a hurdle which removes an athlete's apprehension by removing the bar. That is, there is a virtual bar using a visible ray in which the height control is possible while being supported by the base part. When the body of the player catches on the virtual bar with a sensing means a notification is made.

Various devices are known in the art. However, their structure and means of operation are substantially different from the present disclosure. The other inventions fail to solve all the problems taught by the present disclosure. The present invention and its embodiments provides for a “virtual” hurdle board that can be employed for training purposes, as well as a clip or coupling mechanism for retaining a “competition” hurdle board. Other functionality will be contained under the purview of this invention including applying such concepts to the pole vault and high jump contests. At least one embodiment of this invention is presented in the drawings below and will be described in more detail herein.

### SUMMARY OF THE EMBODIMENTS

Generally, the present invention and its embodiments relate to an athletic training apparatus, namely a hurdle, that can be used to help both novice and more advanced athletes improve their athletic performance. Further, the hurdle is intended to be able to be used for both practices and competitions thereby removing the need for separate training and competition hurdle sets.

In order to achieve these and other objectives, the hurdle generally has at least one light source which may be a high intensity light emitting diode (LED), laser, or the like. The light source is permitted to illuminate an area between a first support and a second support of the device. This creates a “virtual” hurdle board which provides a visual indicator of the position of the hurdle board, if present, would reside. Thus, the athlete can practice their hurdling form and mechanics without fear of hitting or impacting the hurdle itself.

In order to ensure proper form and height clearance, the light sources will change color once interrupted by a barrier such as a leg of an athlete. A light receiver registers this interruption in the light source and causes the light source to change color, for example, from green to red. This indicates that the athlete would have hit the hurdle board had it been in place. This can be communicated to a wireless device for monitoring and resetting of the light source by a coach or other individual. In order to use the hurdle for competition, supports or coupling mechanisms are used to secure an actual hurdle board in place and the light sources are turned off. The resulting set up achieving the same end means as a “typical” competition hurdle.

In one embodiment of the present invention there is an athletic training apparatus having a first support having a first coupling mechanism, wherein the first support is adjustable; a second support having a second coupling mechanism, wherein the second support is adjustable; at least two light sources coupled to the first support; and at least one light receiver couple to the second support.

In another embodiment of the present invention there is an athletic training apparatus having a first support having a first coupling mechanism, wherein the first support is vertically adjustable; a second support having a second coupling mechanism, wherein the second support is vertically adjustable; at least two light sources coupled to the first support; at least one light receiver couple to the second support; and an ultrasonic vaporizer coupled to either the first support or the second support.

In yet another embodiment of the present invention there is an athletic training apparatus having a first support having a first coupling mechanism, wherein the first support is vertically adjustable; a second support having a second coupling mechanism, wherein the second support is vertically adjustable; at least two light sources coupled to the first support; at least one light receiver couple to the second support; a power source operably coupled to the at least two light sources; a support system comprising at least two lower supports and at least two upper supports, wherein the support system is configured to support a hurdle board.

In another aspect of the present invention there is an athletic training system having a training apparatus comprising, a first support having a first coupling mechanism, wherein the first support is vertically adjustable, a second support having a second coupling mechanism, wherein the second support is vertically adjustable, at least two light sources coupled to the first support, at least one light receiver couple to the second support, wherein a first wireless transceiver is operably coupled to the at least one light receiver; and a sensing unit having a second wireless transceiver capable of communicating with the first wireless transceiver.

In general, the present invention succeeds in conferring the following, and others not mentioned, benefits and objectives.

It is an object of the present invention to provide a training apparatus that can be utilized in both competitions and practices.

It is an object of the present invention to provide a training apparatus that uses visible light as a cue.

It is an object of the present invention to provide a training apparatus reduces or prevents injury to athletes.

It is an object of the present invention to provide a training apparatus that provides a visual indication relating to athlete performance.

It is an object of the present invention to provide a training apparatus is easy to set up and use.

It is an object of the present invention to provide a training apparatus that saves costs associated with the purchase of athletic equipment.

It is an object of the present invention to provide a training apparatus that increases an athlete's confidence.

It is an object of the present invention to provide a training apparatus that provides real time feedback regarding the athletic performance.

### BRIEF DESCRIPTION OF THE DRAWINGS

FIG. 1 is a perspective view of an embodiment of the present invention.

FIG. 2 is an embodiment of the present invention being used with an optional hurdle board.

FIG. 3A is a cutaway side view of an embodiment of the present invention demonstrating one possible configuration of the present invention.

FIG. 3B is a cutaway side view of an embodiment of the present invention demonstrating an alternate configuration of the present invention.

FIG. 4 is an example screen from a wireless controller for controlling the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

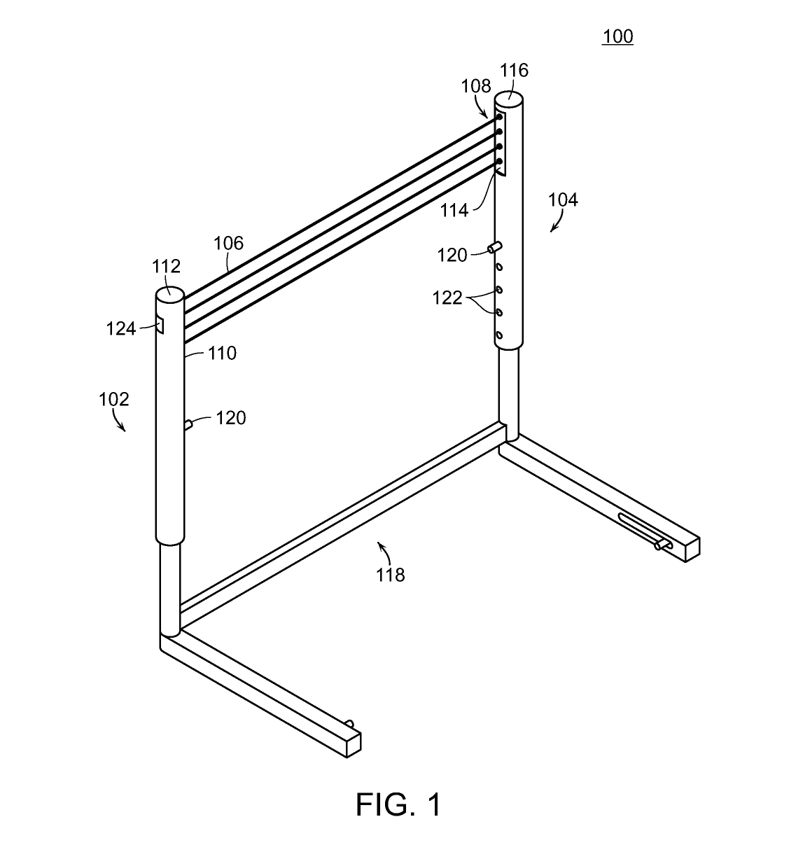

Referring now to FIG. 1, there is an apparatus 100 embodying an athletic hurdle. The apparatus 100 generally has a first support 102, a second support 104, and a base section 118. The base section 118 is preferably coupled to each of the first support 102 and the second support 104. Each of the first support 102 and the second support 104 is preferably height adjustable along a vertical axis. There may be adjustment mechanisms 120 present to help secure the overall height of the apparatus 100. Adjustment slots 122 provide a surface for the adjustment mechanisms 120 to be retained.

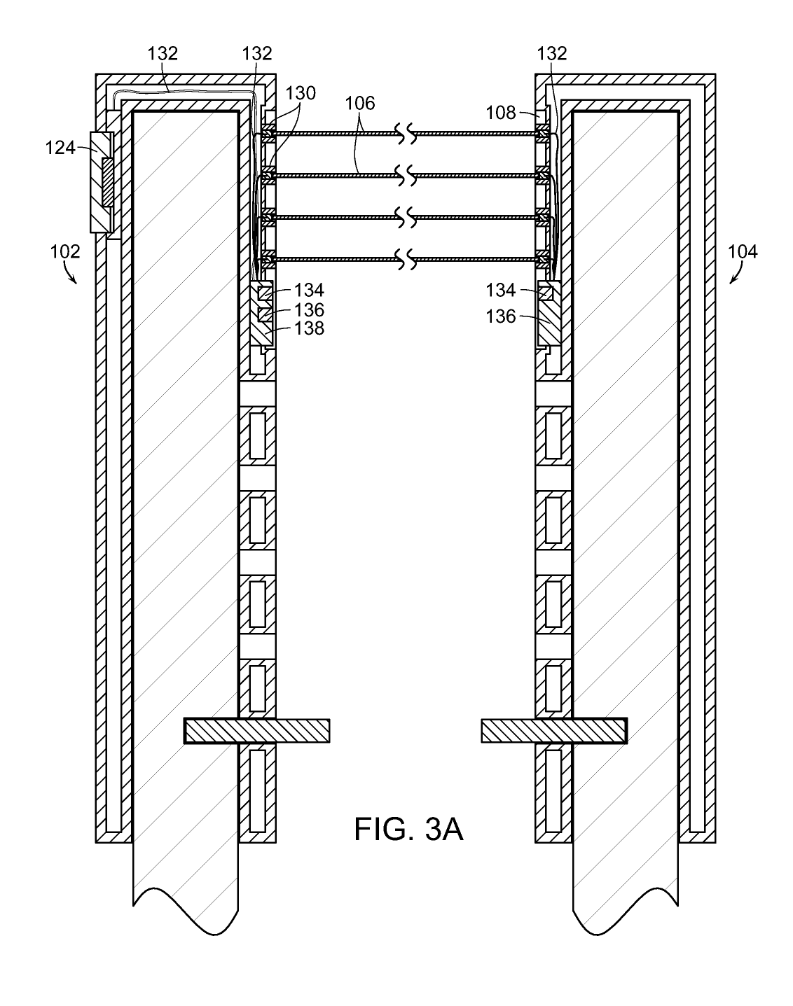

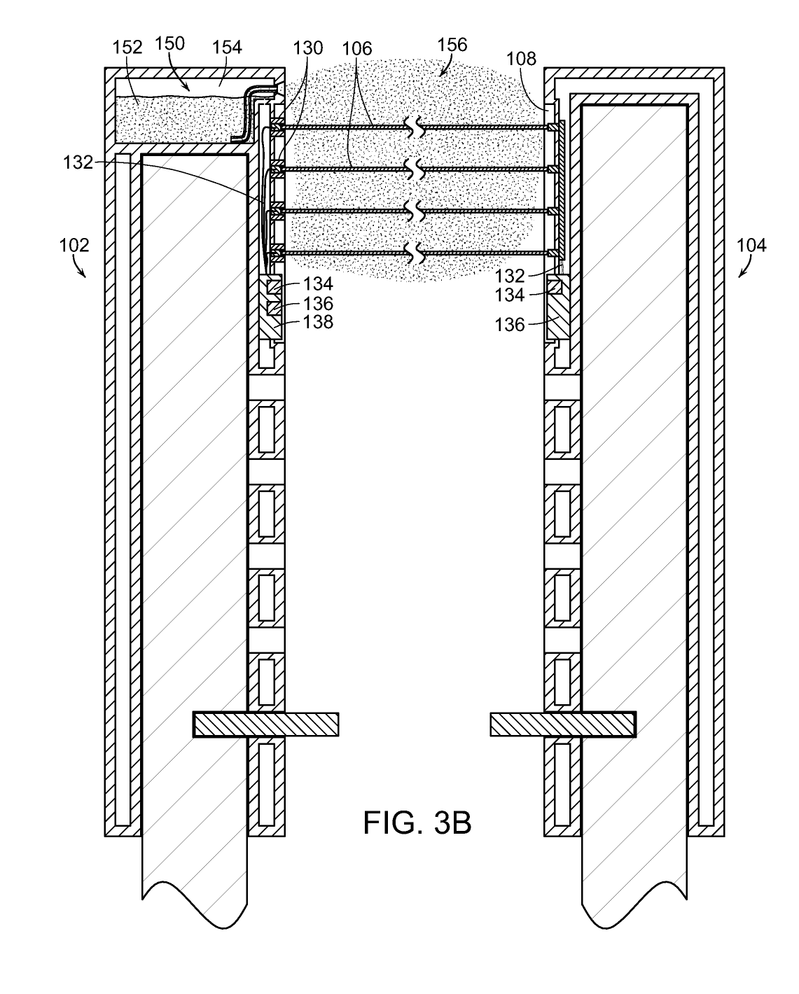

As shown, the apparatus 100 is lacking a barrier or board that is typically seen with similar apparatus. Here, a virtual barrier 106 is created via at least one and preferably at least two visible light sources 130 (see FIG. 3A). The virtual barrier 106 is propagated from the first support 102 to the second support 104. In some embodiments, the virtual barrier 106 may be propagated from the second support 104 to the first support 102. On the opposing support, there is at least one light receiver 108. The light receiver 108 is capable of detecting light emanating from the light sources. A power switch 124 is positioned on the first support 102 and may be capable of changing the operative state of the light sources and/or the at least one light receiver 108.

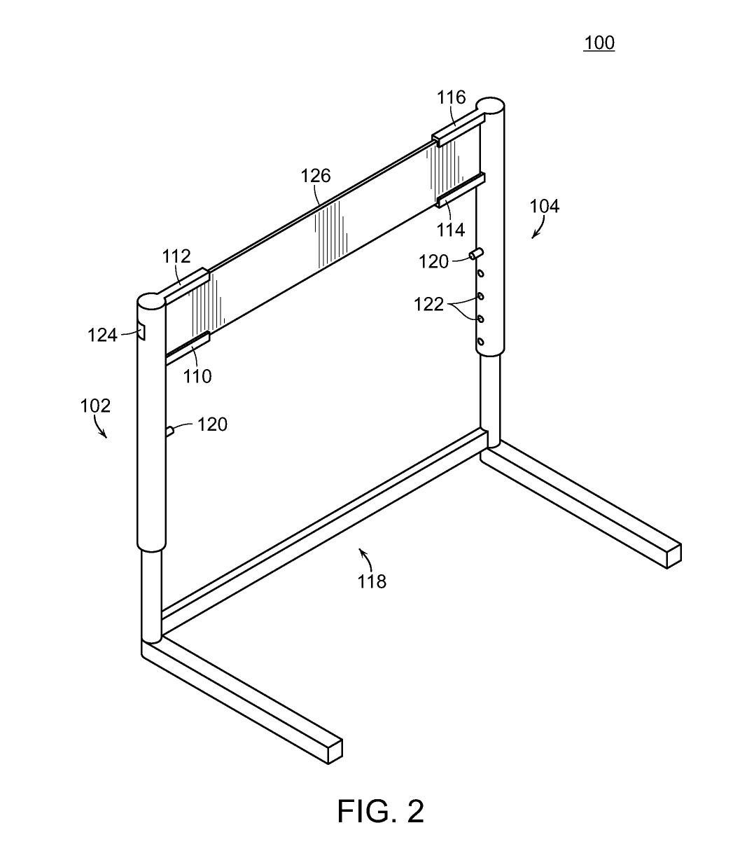

Further, on each of the first support 102 and the second support 104 are coupling mechanisms comprising a supporting system. On the first support 102 there is a first lower support 110 and a first upper support 112. On the second support 104 there is a second lower support 114 and a second upper support 116. When the virtual barrier 106 is to be employed, it is desirable that these supports are positioned to lie flush with or otherwise be obscured by the first support 102 and the second support 104. However, when the supports are intended to be used (see FIG. 2), the supports may be readily extended and positioned to receive a physical hurdle board.

Referring now to FIG. 2, the virtual barrier 106 of the apparatus 100 has been preferably turned off via the power switch 124. The first lower support 110, first upper support 112, second lower support 114, and second upper support 116 have been positioned to receive a physical barrier 126, in this case a hurdle board.

The supports may have a locking mechanism or other structure to secure their position thereby preventing the physical barrier 126 from becoming dislodged during the course of use. A variety of mechanisms may be used including springs, latches, clasps, grooves, and the like to ensure proper securement of the supports.

Thus, the apparatus 100 cannot only be used as a training hurdle, as shown with the embodiment in FIG. 1, but can also be used to meet competition specifications and rules as shown here in FIG. 2.

In FIG. 3A a cutaway view demonstrates one potential arrangement of the internal and external components of the present invention. As shown there is a number of light sources 130 operably coupled to a power source 136. The light sources 130 are further coupled to a power switch 124, wireless transceiver 134, and a printed circuit board 138. Wiring 132 enables at least some of these connections to occur. A light receiver 108 is arranged across from the light sources 130. The light receiver 108 may also have a power source and a wireless transceiver 134.

The power switch 124 may be capable of changing the operative state of the light sources 130 and/or the light receiver 108. In some embodiments, there may be separate power switches 124 for each of the light sources 130 and the light receiver 108. In other embodiments, a wireless signal send to the apparatus may be capable of changing the operative state of these components. Such changes in operative state may include on/off, light intensity, color of light, receiver sensitivity, and the like or any combination thereof.

The light sources 130 preferably emit visible wavelength light that is coherent and/or collimated. The color of the light sources 130 is capable of changing in response to signals received and sent by the light receiver 108. For example, a breaking (by an object) of one of the beams produced by the light sources 130 may cause the light receiver 108 to send a first signal to the wireless transceiver 134 coupled to the light sources 130. The printed circuit board 138 contains components and functionality, such as a processor and firmware, that permits the interpretation of this signal to cause at least one of the light sources 130 to cause a change in color to the light produced.

These components are preferably arranged within the structural components such as the first support 102 and the second support 104 such that the height of the supports may be readily changed without compromising the components contained therein.

In FIG. 3B there is an alternate arrangement of components. Here, many of the components of the embodiment described in FIG. 3A remain the same. However, this embodiment has notably added a water vapor producing mechanism such as an ultrasonic vaporizer 150.

The ultrasonic vaporizer 150 causes water vapor to be produced typically by a piezoelectric transducer. This creates a high frequency mechanical oscillation in a film of water causing the production of the fine misting or droplets of water. The vaporizer as shown has a reservoir 154 with water contained 152 therein. It is desired that the water vapor 156 is then directed out over the virtual hurdle barrier 106. Depending on the particular type(s) of light sources 130 employed, the fine mist of water may be required in order to adequately enable one to visualize the virtual hurdle barrier 106.

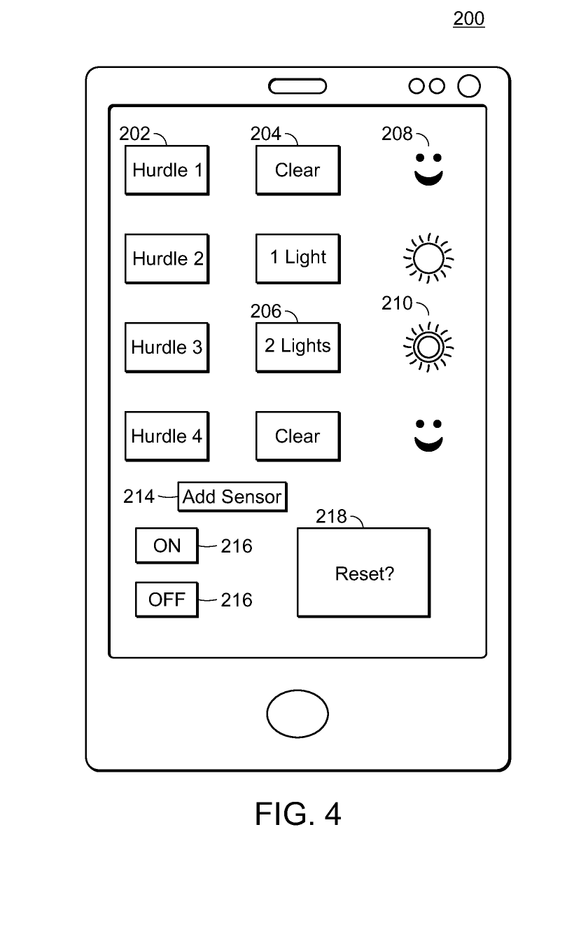

FIG. 4 is an example screen of an electronic device 200 capable of interfacing with the apparatus as described herein. The electronic device may be any number of and type of device including but not limited to smart phones, lap top computers, desktop computers, multimedia players, gaming systems, smart watches, PDAs, and the like or any combination thereof.

The electronic device 200 is preferably capable of running a web and/or mobile based application programmed to interact with the apparatus. The screen has a number of barrier identifiers 202. Each barrier identifier 202 refers to a particular apparatus that is communicatively coupled to the electronic device 200. By using the add sensor 214 functionality, additional barriers may be added and/or removed from the listing.

When in use, the barriers will send a signal to the electronic device 200 from the wireless transceiver discussed above. Any number of status identifiers including a first status identifier 204 and a second status identifier 206 may be sent to the electronic device 200. For example, as shown in FIG. 4, four hurdles are identified. A runner may attempt to hurdle each of the barriers in succession. The status identifiers then relays to the electronic device 200 how many of the light sources were crossed by the athlete, with it being desirable that no lights are triggered. A first status indicator 208 may be used to signify the performance for a barrier. A second status indicator 210 may be used to signify another performance for another barrier. The status indicators may comprise visual, audio, audiovisual, and/or tactile qualities to enable an individual (i.e. a coach) to an athlete's performance.

The individual barriers may be turned on/off using the corresponding power buttons 216. Further, a reset button 218 may be used to reset the light sources and/or the application to allow the same of a different athlete from attempting to traverse the barriers thereafter.

The apparatus described in FIGS. 1-4 may be applied to a variety of training and/or competition contests and may comprise a variety of individual contests or events. For example, in the realm of track and field, the technology may be applicable to any event requiring a barrier such as the hurdles, high jump, pole vault, steeplechase, and the like. The implementation of a virtual barrier for training purposes may be advantageous to prevent undue injury in practice as well as help novices learn the requisite skills without fear of injury.

The light sources 130 to be employed may comprise any number and/or type of light sources and are preferably those which are coherent and/or collimated. This may include laser light which produces a color of light within the visible electromagnetic spectrum. A collimator may be required to achieve the necessary properties of the light. Further, lenses and/or filters may be used to direct the light in a way that makes it both visible and safe.

The light sources 130 may be spaced such that each individual light source 130 is separated by about 0.1 inch to about 6 inches and more preferably about 0.1 inch to about 3 inches. The amount of light sources 130 may vary with more light sources being used in a smaller space resulting in a higher degree of translation of performance.

In other applications, as noted above, outside assistance may be required to help create the visible “virtual” barrier. The use of a fine mist of water vapor may help to ensure the light is visible at all times including bright sunlight conditions. The fine mist may slightly scatter the light enabling its visibility without prematurely causing a tripping of the light receiver 108.

In practice, a coach may set up a number of hurdles in succession. The coach can then ensure that the virtual barriers are enabled and observable. An athlete may then proceed to hurdle each of the barriers. If the individual light source 130 is blocked from the light receiver 108, a first signal is sent from the light receiver 108 to the wireless transceiver 134 coupled to the light source 130 which then causes the color of the light source to change. In some embodiments, there may also be a sound emitted from the barrier, such as a buzzer, which signifies that the light beam was contacted.

Further, as described above in FIG. 4, the coach may be interacting with an electronic device in communication with the apparatus. In totality, a system is created where a coach can have a greater understanding of performance without necessitating the need for video recording and distractions created by such activities. The athlete reaps the benefit of having improved safety and greater confidence in learning or honing a new skill When it's time for competition, the physical barrier is simply put into place and used as a competition piece.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An athletic training apparatus comprising:
a first support having a first coupling mechanism,
wherein the first support is adjustable;
a second support having a second coupling mechanism,
wherein the second support is adjustable;
at least two light sources coupled to the first support; and
at least one light receiver couple to the second support.

2. The apparatus of claim 1 further comprising a base section operably coupled to the first support and/or the second support.

3. The apparatus of claim 1 further comprising a barrier capable of being removably coupled to the first coupling mechanism and the second coupling mechanism.

4. The apparatus of claim 1 wherein the at least two light sources emit visible light.

5. The apparatus of claim 4 wherein the visible light is coherent and/or collimated.

6. An athletic training system comprising:
a training apparatus comprising,
a first support having a first coupling mechanism,
wherein the first support is vertically adjustable,
a second support having a second coupling mechanism,
wherein the second support is vertically adjustable,
at least two light sources coupled to the first support,
at least one light receiver couple to the second support,
wherein a first wireless transceiver is operably coupled to the at least one light receiver; and
a sensing unit having a second wireless transceiver capable of communicating with the first wireless transceiver.

7. The system of claim 6 wherein at least one of the light source changes colors in response to an external stimulus.

8. The system of claim 6 further comprising an ultrasonic vaporizer coupled to either the first support or the second support.

9. The system of claim 6 further comprising a power source.

10. The system of claim 6 wherein the training apparatus is a hurdle.

11. The system of claim 6 wherein the sensing unit is capable of causing a change in color of the at least one light source.

12. The system of claim 7 wherein the at least one light source changes color when a bodily appendage passes therethrough.

13. An athletic training apparatus comprising:
a first support having at least one positioning mechanism,
wherein the positioning mechanism enables the first support to be vertically adjustable;
a second support having at least one positioning mechanism,
wherein the positioning mechanism enables the second support to be vertically adjustable;
a base section coupled to each of the first support and the second support;
at least two light sources coupled to the first support;
at least one light receiver coupled to the second support,
wherein an interruption of at least one of the at least two light sources causes the at least one light receiver to send a first signal to the light source causing the light source to change color;
a power source operably coupled to the at least two light sources and the at least one light receiver; and
a support system comprising at least two lower supports and at least two upper supports,
wherein the support system is configured to support a hurdle board.

14. The apparatus of claim 13 further comprising a power switch,
wherein the power switch changes an operative state of the at least one light sources and/or the at least one light receiver.

15. The apparatus of claim 13 wherein the at least two light sources emit visible light.

16. The apparatus of claim 15 wherein the visible light is coherent and/or collimated.

17. The apparatus of claim 13 further comprising at least one wireless transceiver.

18. The apparatus of claim 17 wherein the at least one wireless transceiver sends data associated with the apparatus to at least one electronic device.

19. The apparatus of claim 18 wherein the at least one electronic device is capable of sending a signal to the apparatus causing a change in an operative state of the apparatus.
